(19) United States
(12) Patent Application Publication
(10) Pub. No.: US 2006/0261511 A1
(43) Pub. Date: Nov. 23, 2006

(54) Process for the preparation of solid blends composed of polyvinylpyrrolidones and of ethoxylated fatty acid derivatives

(75) Inventors: Simone Schillo, Ludwigshafen (DE); Ronald Frans Maria Lange, Ludwigshafen (DE)

Correspondence Address: CONNOLLY BOVE LODGE & HUTZ LLP, P.O. BOX 2207, WILMINGTON, DE, 19899-2207, US

(73) Assignee: BASF Aktiengesellschaft, Ludwigshafen (DE)

(21) Appl. No.: 11/435,850

(22) Filed: May 18, 2006

(30) Foreign Application Priority Data
May 19, 2005 (DE) 102005023803.3

(51) Int. Cl. B29C 47/38

(52) U.S. Cl. 264/211.21

(57) ABSTRACT

Process for preparation of solid blends composed of polyvinylpyrrolidones and of ethoxylated fatty acid derivatives via processing of the components in an extruder, which comprises introducing the polyvinylpyrrolidones into the extruder in the form of aqueous solutions, and removing the solvent during the extrusion procedure.

The present invention relates to an improved process for preparation of solid blends composed of polyvinylpyrrolidones and of ethoxylated fatty acid derivatives, via processing in an extruder.

Ethoxylated fatty acid derivatives are often used as solubilizers for formulations of active ingredients sparingly soluble in water, in order to improve the bioavailability of these active ingredients. Because these fatty acid derivatives are liquid or semisolid at room temperature, incorporation of amounts relevant for effectiveness as solubilizer into formulations often poses problems.

WO 2000/057855 describes the preparation of pulverulent auxiliaries composed of homo- or copolymers of N-vinylpyrrolidone and of liquid or semisolid solubilizers, such as ethoxylated castor oil. The auxiliaries are obtained via spray drying of a solution of the components or via processing of the components in an extruder, where the components are introduced in solid form into the extruder and are melted for the mixing process in the absence of solvent.

However, it has been found that this procedure still requires improvement with respect to efficiency and product stability. For example, spray drying cannot process polymer solutions of relatively high concentration. Melt extrusion in the absence of solvent requires prior work-up of the polymerization solutions. An additional factor is that demixing via phase separation of the components can occur with relatively high loadings, using the ethoxylated fatty acids in the procedures described.

It was an object of the present invention to provide an improved process which can prepare blends composed of polyvinylpyrrolidones and of ethoxylated fatty acid derivatives and which eliminates the disadvantages described.

Accordingly, a process has been found for preparation of solid blends composed of polyvinylpyrrolidones and of ethoxylated fatty acid derivatives via processing of the components in an extruder, which comprises introducing the polyvinylpyrrolidones into the extruder in the form of aqueous solutions, and removing the solvent during the extrusion procedure.

According to the invention, polyvinylpyrrolidones are the homo- and copolymers of N-vinylpyrrolidone with Fikentscher K values of from 12 to 100, preferably from 17 to 30. Copolymers especially suitable are copolymers with vinyl esters of C₁-C₂₀ carboxylic acids, e.g. vinyl acetate, vinyl propionate, vinyl laurate, or vinyl stearate, preferably vinyl acetate. Amounts of up to 60% by weight of the vinyl ester comonomers can be present. Polyvinylpyrrolidones particularly preferably used are the homopolymer or copovidone, a copolymer composed of N-vinylpyrrolidone and vinyl acetate in quantitative proportion of 60/40. The Fikentscher K values can be from 10 to 100. The polyvinylpyrrolidones are used in the form of aqueous solutions whose solids contents are from 30 to 70% by weight, preferably from 40 to 60% by weight.

Ethoxylated fatty acid derivatives are reaction products of ethylene oxide with castor oil, or with hydrogenated castor oil, or 12-hydroxystearic acid. Examples of suitable products are polyoxyethylene glycerol ricinolate 35, polyoxyethylene glycerol trihydroxystearate, PEG 660-12-hydroxystearic acid (polyglycol ester of 12-hydroxystearic acid with 30 mol % of ethylene glycol), or preferably a reaction product of 1 mol of hydrogenated castor oil with 45 mol of ethylene oxide (Cremophor® RH40).

Blends are mixtures of chemically different components. In the case of the present invention, the blends are composed of a thermoplastic polyvinylpyrrolidone component and of an ethoxylated fatty acid derivative, and the blends here cannot be broken down by physical methods to give the individual components.

According to the invention, the blends comprise from 40 to 90% by weight, preferably from 50 to 80% by weight, of a polyvinylpyrrolidone and from 10 to 60% by weight, preferably from 20 to 50% by weight, of an ethoxylated fatty acid derivative, the stated amounts being based on the total weight of the blend.

The blends are prepared via joint processing of an aqueous solution of a polyvinylpyrrolidone and of an ethoxylated fatty acid derivative in the extruder.

In principle, the usual types of extruder known to the person skilled in the art are suitable for the inventive process. These usually comprise a barrel, a drive unit, and also a plastifying or mixing unit composed of one or more rotors (screws) provided with conveying or kneading elements, and also apparatus for solvent removal.

Along the screws in the direction of transport there are two or more sections which comprise, in the inventive process, a feed zone and conveying zone, a mixing zone, and a metering zone. Vent zones may also be present, and this devolatilization can take place at atmospheric pressure and/or in vacuo. The vacuum devolatilization process can, by way of example, use a stuffing screw and a steam-jet pump.

Each of these sections can in turn comprise one or more barrel sections as smallest independent unit.

The blends can be prepared in a twin-screw extruder or in multiscrew extruders, but preferably in a twin-screw extruder. If multiscrew extruders are used, two or more screws can be of corotating tightly intermeshing design. The design of the extruder is preferably corotating and tightly intermeshing. The individual barrel sections are to be heatable. The barrel sections may also have been designed for cooling, for example for cooling with water.

The screws may be composed of any of the elements conventional in the extrusion process. They may comprise not only conventional conveying elements but also kneading disks or reverse-conveying elements. A person skilled in the art can use simple trials to determine which screw configuration is suitable in an individual case. Two or more extruders arranged in series can also be used.

In order to achieve sufficient mixing of the components, the residence time of the material in the extruder is selected to be appropriately long. This can be controlled by way of the extruder dimensions, a property utilized being the ratio of screw length to screw diameter. According to the invention, the ratio of screw length to screw diameter (L/D ratio) can be from 40:1 to 70:1, preferably from 50:1 to 60:1.

The extruder used according to the invention in essence divides into the following sections:

In a first section, the solution of the polyvinylpyrrolidone is introduced into the extruder. The screw geometry in this section corresponds to the conventional conditions for conveying. Following the barrel section provided with a feed apparatus there are two or more barrel sections, for example from three to six, and these may have been equipped with apparatus for applying a vacuum or for devolatilization. The polymer solution is preferably subjected to prior deaeration or devolatilization prior to addition of the fatty acid derivative in the next section. The devolatilization/deaeration process takes place at pressures of from 0.005 to 0.1 MPa, preferably at atmospheric pressure. This removes some of the water.

In a second section, designed as a mixing zone, the ethoxylated fatty acid derivative is added. The components are then intimately mixed so that the polyvinylpyrrolidone becomes homogeneously dispersed with the ethoxylated fatty acid derivative. This section likewise comprises conventional conveying elements. In order to convey the mixture it can be advisable also to incorporate kneading disks. It can also be advisable to incorporate reverse-conveying elements for additional improvement of the mixing process. Two or more barrel sections, for example from 3 to 6 barrel sections, are likewise normally provided for this section.

The melt is then further conveyed in the direction of the discharge orifice. As a function of the amount of melt to be processed, this section can be composed of from one to three barrel sections.

In the third section, between mixing zone and discharge orifice, there may also be another devolatilization zone with one or more barrel sections, and the devolatilization process here can take place at atmospheric pressure and/or in vacuo. The devolatilization preferably takes place at pressures of from 0.005 to 0.1 MPa. Between the devolatilizating zone and the discharge orifice, there may be further barrel sections.

The melt, still plastic, is then discharged from the extruder. The method of discharge may use conventional die plates, pelletizing dies, or other suitable apparatus. The die used preferably comprises a slot die. According to another preferred embodiment, the melt can be discharged by way of the open extruder head.

The jacket temperature of the zone to which the polyvinylpyrrolidone solution is charged is usually from 20 to 30° C. All of the other zones, and also the transition pieces between extruder and die plate, and also the actual die plate, are heated in order to ensure that the melt is plasticized.

The jacket temperature of the extruder barrel sections and the temperature at the discharge orifice will usually be from 60 to 150° C., preferably from 100 to 140° C.

After discharge, the blend, still plastic, is cooled. This process can take place at room temperature or via cooling with a stream of cold gas, such as air or nitrogen. Another possibility is freeze drying, for example in liquid nitrogen.

After cooling, shaping can take place by suitable apparatus known per se, for example via cutting or grinding of the cooled blend. For grinding processes, freeze-dried blends are particularly suitable.

The blends obtained by the inventive process are stable mixtures in which the components are present in the form of a homogeneous dispersion. No phase separation takes place even after two or more months of storage.

### EXAMPLE

A solid blend is prepared from copovidone and Cremophor RH40 in a ratio of 1:1 by weight. The copovidone was used in the form of a 50% strength by weight aqueous solution.

The components were processed in a ZSK 30 twin-screw extruder from Coperion Werner & Pfleiderer, equipped with conveying and mixing elements and also with vents. The extruder was composed of 18 barrel sections and of a die head, the overall L/D ratio being 56:1. The extruder was operated at a rotation rate of 150 rpm with a throughput of 5 kg/h. The aqueous copovidone solution was continuously introduced by way of a pump into barrel section 1 with a jacket temperature of 30° C. This was followed by a devolatilizing zone composed of 5 barrel sections (jacket temperatures: 80/140/140/140/140° C.), this devolatilizing process taking place at atmospheric pressure, and also by a further barrel section, the jacket temperature of which was 120° C. In the barrel section following this, Cremophor RH40 was continuously metered in, the jacket temperature being 100° C. In the mixing zone following this, composed of four barrel sections, the jacket temperature was 80° C. Following this there was a conveying and devolatilizing zone composed of six barrel sections and operated with jacket temperatures of 100° C. The devolatilizing process took place under a slight vacuum (0.090 MPa). The melt was then discharged by way of a die at a die temperature of 100° C., and cooled.

The resultant solid blend was a homogeneous mass which exhibited no demixing even after 6 months of storage at 20° C.

1. A process for preparation of solid blends composed of polyvinylpyrrolidones and of ethoxylated fatty acid derivatives via processing of the components in an extruder, which comprises introducing the polyvinylpyrrolidones into the extruder in the form of aqueous solutions, and removing the solvent during the extrusion procedure.

2. The process according to claim 1, wherein the solids contents of the aqueous solutions of the polyvinylpyrrolidones are from 30 to 70% by weight.

3. The process according to claim 1, wherein the removal of the solvent takes place at pressures of from 0.005 to 0.1 MPa.

4. The process according to claim 1, wherein the jacket temperatures during the preparation process are from 60 to 150° C.

5. The process according to claim 1, which uses an extruder in which the ratio of screw length to screw diameter is from 40:1 to 70:1.

6. The process according to claim 1, wherein the polyvinylpyrrolidone used comprises a copolymer of N-vinylpyrrolidone and vinyl acetate in a ratio of 6:4 by weight.

7. The process according to claim 1, wherein the ethoxylated fatty acid derivative used comprises a reaction product derived from 1 mol of hydrogenated castor oil with 45 mol of ethylene oxide.

8. The process according to claim 1, wherein the resultant blends comprise from 40 to 90% by weight of polyvinylpyrrolidone and from 10 to 60% by weight of ethoxylated fatty acid derivatives.

9. The process according to claim 1, wherein the resultant blends comprise from 50 to 80% by weight of polyvinylpyrrolidones and from 20 to 50% by weight of ethoxylated fatty acid derivatives.

10. The process according to claim 2, wherein the removal of the solvent takes place at pressures of from 0.005 to 0.1 MPa.

11. The process according to claim 2, wherein the jacket temperatures during the preparation process are from 60 to 150° C.

12. The process according to claim 3, wherein the jacket temperatures during the preparation process are from 60 to 150° C.

13. The process according to claim 2, which uses an extruder in which the ratio of screw length to screw diameter is from 40:1 to 70:1.

14. The process according to claim 3, which uses an extruder in which the ratio of screw length to screw diameter is from 40:1 to 70:1.

15. The process according to claim 4, which uses an extruder in which the ratio of screw length to screw diameter is from 40:1 to 70:1.

16. The process according to claim 2, wherein the polyvinylpyrrolidone used comprises a copolymer of N-vinylpyrrolidone and vinyl acetate in a ratio of 6:4 by weight.

17. The process according to claim 3, wherein the polyvinylpyrrolidone used comprises a copolymer of N-vinylpyrrolidone and vinyl acetate in a ratio of 6:4 by weight.

18. The process according to claim 4, wherein the polyvinylpyrrolidone used comprises a copolymer of N-vinylpyrrolidone and vinyl acetate in a ratio of 6:4 by weight.

19. The process according to claim 5, wherein the polyvinylpyrrolidone used comprises a copolymer of N-vinylpyrrolidone and vinyl acetate in a ratio of 6:4 by weight.

20. The process according to claim 2, wherein the ethoxylated fatty acid derivative used comprises a reaction product derived from 1 mol of hydrogenated castor oil with 45 mol of ethylene oxide.
